(19) United States
(12) Patent Application Publication
(10) Pub. No.: US 2026/0356721 A1
(43) Pub. Date: Nov. 12, 2026

(54) ELECTRIC GLASS-MAKING FURNACE

(71) Applicant: SAINT-GOBAIN ISOVER, COURBEVOIE (FR)

(72) Inventors: Michel LISMONDE, AUBERVILLIERS (FR); Stéphane MAUGENDRE, AUBERVILLIERS (FR); Romain SANTAMARIA, AUBERVILLIERS (FR); Philippe DE DIANOUS, AUBERVILLIERS (FR); Joel GERVAIS, AUBERVILLIERS (FR)

(21) Appl. No.: 19/130,759

(22) PCT Filed: Nov. 17, 2023
(86) PCT No.: PCT/EP2023/082229

§ 371 Date: May 16, 2025

(30) Foreign Application Priority Data
Nov. 18, 2022 (FR) 2211995

(51) Int. Cl. C03B 5/03

(52) U.S. Cl. CPC C03B 5/031

(57) ABSTRACT

An at least partially electric glass furnace includes a melting tank made of refractory materials that is suitable for containing a bath of molten vitrifiable materials and a plurality of top-entering heating electrodes, which are immersed from the free surface of the bath and supplied with electric current by an electrical installation. The electrical installation is configured to generate a two-phase alternating current. This makes it possible to heat larger furnaces/reduce the number of electrodes.

The present invention belongs to the general field of glass production. It relates more particularly to an at least partially electric glass furnace suitable for melting vitrifiable materials. It also relates to a method for melting vitrifiable materials so as to be able to manufacture glass. The invention finds a particularly advantageous application, although by no means limiting, in the production of glass wool, rock wool, textile glass yarns and/or flat or hollow glass.

In the present description, “vitrifiable materials” or “raw materials” is understood to mean all materials, natural ores or synthesized products, materials derived from recycling such as cullet, etc., which can enter the composition that feeds a glass furnace. This includes silica sand, but also all additives (sodium carbonate, limestone, dolomite, alumina, etc.), waste materials (including mineral fibers) that may be produced from the production of said fibers or from construction or deconstruction sites, all possible liquid or solid fuels (composite or non-composite plastics, organic materials, coals), and any type of cullet. Also included are recyclable materials containing combustible (organic) elements such as, for example, sizing mineral fibers with a binder (of the type used in thermal or acoustic insulation or those used in the reinforcement of plastics), glazings laminated with sheets of polyvinyl butyral polymers such as windshields, glass bottles (household cullet), or any type of “composite” material combining glass and plastic materials such as certain bottles. Also recyclable are “glass-metal composites or metal compounds” such as functionalized glazings with coatings containing metals. In the description, “bath of vitrifiable materials” or “glass bath” refer to the product of the melting of these raw materials.

Likewise, “glass” is understood to mean glass in the broad sense, that is, encompassing any material with a vitreous, glass-ceramic or ceramic matrix.

In addition, the term “manufacturing” comprises the indispensable step of melting the vitrifiable materials and, if necessary, all the subsequent steps of refining/conditioning the molten glass for its final shaping, in particular in the form of flat glass (glazings), hollow glass (bottles, jars), glass in the form of mineral wool (in particular rock wool or glass wool) used for its thermal or sound insulation properties, or even optionally glass in the form of textile yarns used in reinforcement.

Various examples of electric furnace designs are known from the state of the art, and in particular from patent EP0671116B1, wherein the current is conducted in the bath of vitrifiable materials by so-called “top-entering” electrodes, which are immersed from the free surface of the bath. This type of top-entering electrode differs in particular from so-called “submerged” electrodes, which are arranged vertically in the bath from the furnace floor or horizontally, passing through the side walls of the furnace. Compared with the latter, top-entering electrodes offer a number of advantages. First of all, they avoid the difficulties associated with the passage of immersed electrodes through the bottom or side wall refractory, and also the problems of replacing these electrodes when worn, as well as problems with the sealing of the melting tank or else with refractory wear, due in particular to high temperatures which favor refractory attack and to powerful convection currents which develop in the vicinity of the electrodes during operation.

These top-entering electrodes are usually supplied with three-phase current. Three-phase current offers numerous advantages, not least the fact that it is the so-called “industrial” current that is commonly distributed to plants by energy suppliers, hence the resulting adaptation of machines. Three-phase current also delivers instantaneous power with no pulsed component, unlike single-phase current, for example. It should be noted, however, that the principle of phase equilibrium tends towards a triangular or hexagonal arrangement of electrodes on the surface of the glass bath. While such a geometric constraint does not seem to pose a problem a priori in the context of a small electric furnace, it does pose a problem in the context of a large electric furnace, where the glass bath extends over more than 25 m², preferentially more than 40 m², or even more than 100 m², and wherein the edge-to-edge width of the glass bath is greater than 5 m, preferentially greater than 6.5 m. In such a configuration and in view of the aforementioned geometric constraints, the current tends to concentrate between the electrodes of the same and/or adjacent tank edges, thus reducing the distance covered by the current within the glass bath and therefore the resistance of the glass bath to the passage of this current. For a predetermined electrical power corresponding to the energy required to melt the vitrifiable materials, and in the context of a glass bath offering only reduced resistance, it is thus necessary to increase the intensity of the current delivered. However, wear on the electrodes and refractories making up the tank increases with the intensity of the current delivered per electrode. To overcome this problem of wear, the natural solution is to distribute the current delivered between a greater number of electrodes. However, this has the disadvantage of increasing the operating costs of these electrodes-since there are more of them-without solving certain problems of inhomogeneity in the distribution of the electric current within the glass bath.

The aim of the present invention is to remedy some or all of the disadvantages of the prior art, in particular those set out above.

To this end, and according to a first aspect, the invention relates to an at least partially electric glass furnace, comprising a melting tank made of refractory materials that is suitable for containing a bath of molten vitrifiable materials and a plurality of top-entering heating electrodes, which are immersed from the free surface of said bath and supplied with electric current by an electrical installation, said furnace being characterized in that said electrical installation is configured to generate a two-phase alternating current.

For the purposes of this invention, the term “two-phase alternating current” refers to a system with two phases of the same frequency and amplitude that are in quadrature, i.e. 90° or π/2 radians out of phase with each other.

In a contemporary context, where current is distributed by energy suppliers in three-phase form, the implementation of an electrical installation adapted to convert this three-phase current into a two-phase current implies an a priori unnecessary technical complexity and a non-negligible increase in the initial cost of this technical installation.

In spite of these a priori prohibitive disadvantages and in the specific context of supplying top-entering electrodes of glass furnaces, the inventors have found that such a two-phase system enables a glass furnace designer to free himself from certain geometric constraints specific to three-phase systems and the associated technical disadvantages, including the large number of electrodes to be used and the inhomogeneous distribution of the electric current within the bath of vitrifiable materials.

In contrast, a two-phase system offers a glass furnace designer the possibility of spacing the electrodes fed by the same phase further apart, for example by positioning them in the vicinity of opposite edges of the melting tank. Compared with a three-phase system, and for a given electrical power, the resistance generated by the glass bath—which increases with the distance covered by the current therewithin—is greater, which implies a reduction in the electrical current to be delivered. It is then possible to distribute this intensity between a reduced number of electrodes and/or to limit the intensity delivered to each electrode, thus increasing their service life.

According to a particular embodiment, said electrical installation comprises at least one two-phase transformer adapted to generate two single-phase output groups with a 90° phase difference between each output group, each output group supplying at least one pair of said electrodes.

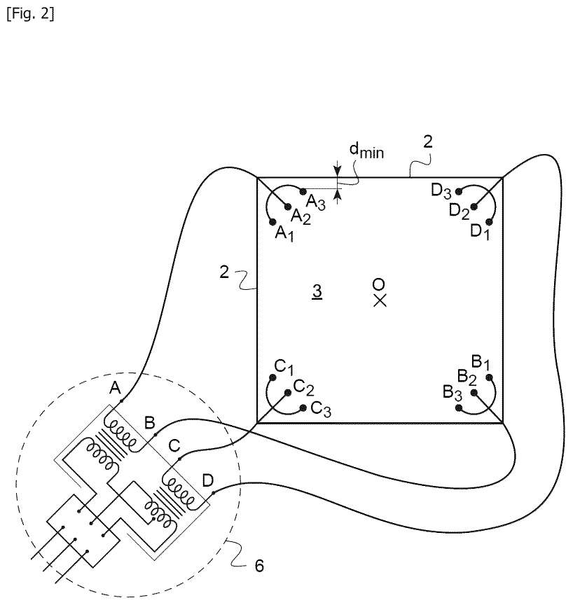

For the purposes of the invention, the term “output group” refers to a set of phase-aligned outputs of the two-phase transformer. Conventionally, and as shown in FIG. 2 and in the description for a particular embodiment of the invention, an output group only comprises a single output which is connected to a plurality of electrode pairs (three in the embodiment shown in FIG. 2), which it supplies with single-phase alternating current.

According to a particular embodiment, at least one output group of said at least one two-phase transformer feeds a bundle of at least two electrode pairs, preferentially three electrode pairs.

Connecting an output group to a bundle or, in other words, to a plurality of electrode pairs, enables the current intensity to be distributed therebetween, thus limiting wear on each of them over time. On the contrary, the use of a single pair of electrodes fed by a group of outputs limits the initial cost of the installation.

According to a particular embodiment, at least one output group of said at least one two-phase transformer comprises one or more outputs.

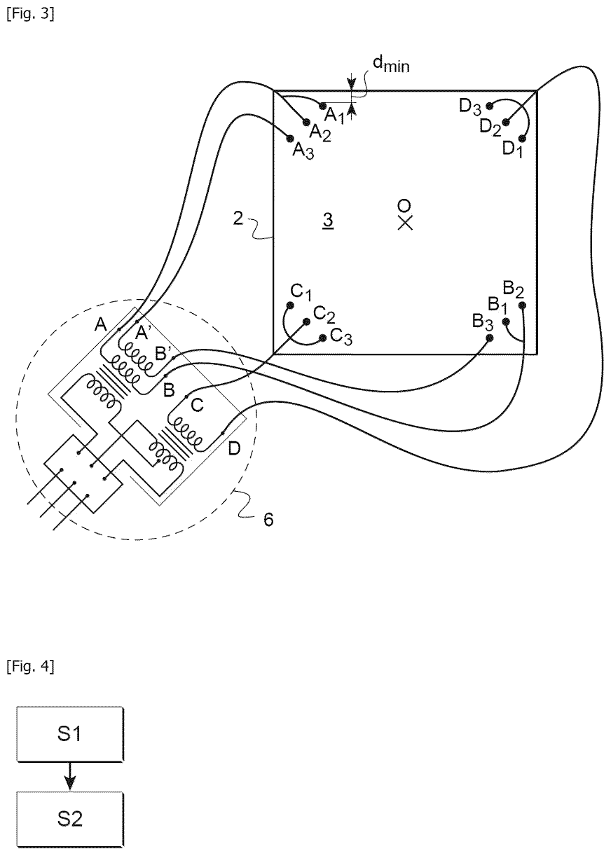

According to this alternative embodiment shown in particular in FIG. 3, an output group comprises several outputs, mounted for example in parallel, each output being connected to one or more pairs of electrodes. In all cases, the single-phase current delivered to each of these electrodes is phase-aligned.

According to a particular embodiment, each electrode bundle is arranged in the bath of molten vitrifiable materials in such a way as to respect a central symmetry along a theoretical horizontal plane.

Respecting such an axial symmetry ensures a more even distribution of current between the electrodes, and therefore limits the likelihood of one of these electrodes wearing out more quickly than the others.

According to a particular embodiment, the electrodes of the same output group are arranged in the vicinity of opposite walls of the tank.

This advantageous geometric arrangement of electrode pairs is particularly well suited to two-phase operation, wherein the distance between electrodes connected to the two terminals of the same output group can be increased without the risk of electrodes arranged close to the same wall exchanging with each other.

According to a particular embodiment, said pairs of electrodes powered by the same two-phase transformer are arranged in a quadrilateral along a theoretical horizontal plane, preferentially in a rectangle, preferentially in a square, in the bath of molten vitrifiable materials.

This advantageous geometric arrangement of pairs of electrodes is particularly suited to two-phase operation, and enables currents to be balanced. Such a quadrilateral arrangement contrasts in particular with the arrangements of triangular or hexagonal shapes, which are typical of three-phase systems.

According to a particular embodiment, the minimum distance between each electrode and the nearest tank wall is greater than 450 mm, preferentially greater than 600 mm, more preferentially greater than 800 mm, preferentially greater than 950 mm, preferentially greater than 1075 mm.

For the purposes of the invention, such a minimum distance is measured along the normal to the tank wall closest to the electrode, and which passes therethrough. Note that the convection movements of the glass bath generated in the vicinity of each electrode tend to corrode the adjoining wall of the tank. Moving the electrode away from the tank therefore limits this premature wear of the tank wall.

According to a particular embodiment, each of said electrodes comprises a horizontal projection arm, preferentially of square cross-section, the horizontal extension of which is greater than 2000 mm, preferentially greater than 2500 mm, preferentially greater than 3000 mm, preferentially greater than 3500 mm, preferentially greater than 3700 mm, preferentially greater than 3900 mm.

The use of an electrode arm with a square cross-section gives it greater resistance to bending. This is particularly useful when the electrode arm is long. In particular, a long electrode arm allows the electrode to be moved further away from the adjoining tank wall, in order to limit wear on the latter. This distance between the electrode and the wall of the tank is all the more advantageous when the furnace power is increased. Since power depends on voltage and current, these two parameters are then adjusted to higher values as power increases. The result is an intensification of the glass bath convection movements generated in the vicinity of each electrode which tend to corrode the adjoining wall of the tank. Moving the electrode away from the tank wall limits this premature wear of the tank wall.

According to a particular embodiment, said electrical installation is adapted so that all pairs of electrodes connected to the same output group of said two-phase transformer are supplied with an electrical current of the same voltage.

According to a particular embodiment, the glass furnace is fully electric, and preferentially comprises a cold crown (5).

For the purposes of the invention, a furnace is said to be “fully electric” in the sense that all the heating energy supplied to the glass bath is of an electrical nature. Such a furnace thus lacks heating burners.

According to a particular embodiment, the glass furnace comprises a plurality of said two-phase transformers, preferentially three.

The use of a plurality of two-phase transformers is particularly suitable for supplying power to large furnaces, where the use of a two-phase system is particularly advantageous.

According to a particular embodiment, said melting tank is dimensioned so that said bath of molten vitrifiable materials has a surface area greater than 25 m² , preferentially greater than 40 m², preferentially greater than 60 m², preferentially greater than 100 m², and preferentially has a distance between two opposite walls of said tank greater than 5 m, preferentially greater than 6.5 m.

Such dimensions relate to so-called large electric furnaces, for which the use of a two-phase system is particularly advantageous.

The construction of these so-called large electric furnaces usually comes up against technical obstacles for the skilled person.

The first obstacle is the need for greater electrical power to melt vitrifiable materials. This greater electrical power leads to higher currents and voltages at the electrodes, intensifying the convection movements of the glass bath generated in the vicinity of each electrode, which tend to corrode the adjoining tank wall.

The second obstacle is that the larger the area of these furnaces, the greater the length and width of the basin. It is therefore necessary to be able to supply heating energy to any point, including to the center of the furnace, the area furthest from the wall.

The present invention solves these obstacles by synergistically combining the use of a two-phase system with arms whose horizontal extension is greater than 2000 mm, preferentially greater than 2500 mm, preferentially greater than 3000 mm, preferentially greater than 3500 mm, preferentially greater than 3700 mm, preferentially greater than 3900 mm. This synergy is based on the fact that, for a given power level, a two-phase system allows less current at the electrodes than a three-phase system. This shows that it is possible to obtain a higher power output for the same current. This possibility of having greater power or even greater current is associated with arms having a greater horizontal extension. These arms, with their greater horizontal extension, enable the electrodes to be moved further away from the walls thereby reducing the risk of corrosion of the tank walls while at the same time enabling the heating of remote areas. In addition, the use of a two-phase system reduces the number of electrodes and therefore the cost of the installation. The number of electrodes per square meter (m²) is between 0.1 and 0.45, preferably between 0.15 and 0.4 and even more preferably between 0.2 and 0.35.

According to a particular embodiment, these so-called large furnaces are obtained by adding several elementary modules. An elementary module is then considered to be the equivalent of a furnace whose tank has a length and width of a defined value, this elementary module comprising a series of heating electrodes having a defined arrangement. Preferably, the elementary module is square-shaped. A so-called large furnace then comprises at least two elementary modules arranged contiguously, i.e. it comprises a tank whose length and width dimensions are multiples of the defined value of the elementary module. It is then possible to simply obtain a so-called large furnace, which can have various shapes such as rectangular, square, L-shaped or T-shaped.

According to a particular embodiment, said two-phase transformer supplies a number of electrodes less than or equal to 16, preferentially less than or equal to 12, preferentially less than or equal to 8.

Depending on whether each output group supplies twice four electrodes, twice three electrodes or twice two electrodes, the total number of electrodes supplied by a single two-phase transformer thus varies between 16, 12 and 8 electrodes respectively.

Compared with a three-phase system and for a glass bath module of equivalent surface area—and therefore equivalent electrical power—the two-phase system offers the possibility of reducing the number of electrodes used in the furnace.

According to a particular embodiment, the invention relates to a method for melting vitrifiable materials implemented by means of such a glass furnace, characterized in that it comprises at least one step of electrically heating said bath of molten vitrifiable materials by means of said plurality of electrodes, and by applying within said bath a two-phase alternating current.

According to a particular embodiment, all pairs of electrodes connected to the same output group of said two-phase transformer are supplied with an electric current of the same voltage.

According to a particular embodiment, the invention relates to a method for manufacturing glass wool, rock wool, glass textile yarns and/or flat or hollow glass, characterized in that it implements such a melting method.

Other features and advantages of the present invention will emerge from the non-limiting description given below, with reference to the appended drawings that illustrate an exemplary embodiment thereof. In the figures:

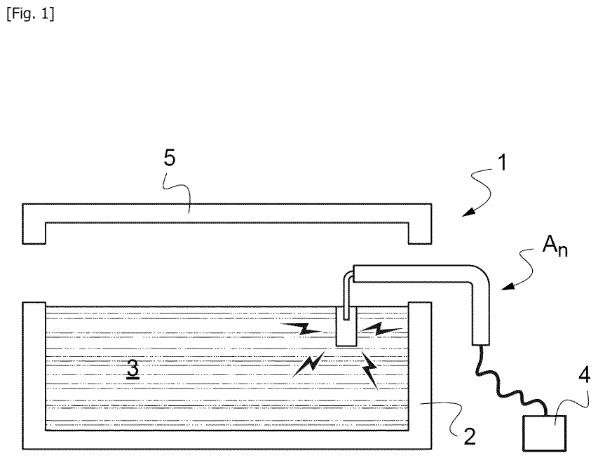

FIG. 1 shows a schematic profile view of an electric glass furnace;

FIG. 2 shows a schematic top view of the glass bath and top-entering electrodes of an electric furnace according to a particular embodiment of the invention;

FIG. 3 shows a schematic top view of the glass bath and top-entering electrodes of an electric furnace according to an alternative embodiment of the invention;

FIG. 4 is a flowchart showing the successive steps of a manufacturing method according to a particular embodiment of the invention.

FIG. 1 shows a schematic profile view of an electric glass furnace 1. Such a glass furnace 1 comprises a melting tank 2 made of refractory materials that is suitable for containing a bath 3 of molten vitrifiable materials and a plurality of top-entering heating electrodes (An, Bn, Cn, Dn) (only one is shown in FIG. 1, for simplification purposes), the arms of which have a square cross-section, and which are immersed from the free surface of said bath 3 and supplied with electric current by an electrical installation 4. As is well known, the part of the electrode in contact with the glass bath is composed of molybdenum. A glass furnace 1 according to the invention is particularly characterized in that said electrical installation 4 is adapted to generate a two-phase alternating current.

According to the particular embodiment shown in FIG. 1, the furnace 1 is fully electric and is equipped with a cold crown 5.

According to a particular embodiment, and as shown by FIG. 2, said electrical installation comprises a two-phase transformer 6 adapted to generate two single-phase output groups (A-B, C-D) with a 90° phase difference between each output group (A-B, C-D). According to this particular embodiment, an output group only comprises a single output (A-B, C-D) which is connected to a bundle of three pairs of electrodes ((An; Bn); (Cn; Dn) with n=1,2,3), which it supplies with single-phase alternating current. The bundles of electrodes are arranged in the bath 3 in a substantially square shape and in such a way as to respect a central symmetry along a theoretical horizontal plane, with respect to a point O located in the center of the bath 3.

According to this alternative embodiment shown in FIG. 3, the first output group comprises several outputs (A-B, A′-B′) mounted in parallel, the first output A-B being connected to a bundle of two pairs of electrodes ((An; Bn); (Cn; Dn) with n=1,2), while the second output A′-B′ is connected to a single pair of electrodes (A3; B3). In all cases, the single-phase current delivered to each of these electrodes is in phase alignment.

In practice, a first single-phase current is generated by the transformer 6 at the terminals of a first output group A-B and passes through the glass bath between electrodes A1, A2, A3 on the one hand, and electrodes B1, B2, B3 on the other hand, thus heating the bath 3 of vitrifiable materials by Joule effect. In parallel, a second single-phase current, of the same frequency and amplitude as the first current, but phase-shifted by 90° or π/2 radians with respect to the latter, is generated by the transformer 6 at the terminals of a second output group C-D and passes through the glass bath between electrodes C1, C2, C3 on the one hand, and electrodes D1, D2, D3 on the other, thus heating the bath 3 of vitrifiable materials by Joule effect. Overall, the electrical installation 6 is thus adapted to generate a two-phase alternating current within the glass bath 3.

According to the embodiments shown in FIGS. 2 and 3, the electrical installation comprises only a two-phase transformer 6 which supplies a “block” of electrodes (An, Bn, Cn, Dn). According to alternative embodiments not shown, relating in particular to large electric furnaces, the electrical installation comprises a plurality of two-phase transformers which respectively feed a plurality of electrode blocks covering the surface of the glass bath 3.

FIG. 4 is a flow diagram showing the successive steps of a manufacturing method according to a particular embodiment of the invention, which comprises a first step S1 of melting vitrifiable materials by electrically heating said bath 3 of vitrifiable materials by means of a two-phase alternating current, and a second step S2 of manufacturing glass wool, rock wool, glass textile yarns and/or flat or hollow glass.

1. A glass furnace at least partially electric, comprising a melting tank made of refractory materials that is suitable for containing a bath of molten vitrifiable materials and a plurality of top-entering heating electrodes, which are immersed from a free surface of said bath and supplied with electric current by an electrical installation, wherein said electrical installation is configured to generate a two-phase alternating current.

2. The glass furnace according to claim 1, characterized in wherein said electrical installation comprises at least one two-phase transformer adapted to generate two single-phase output groups with a phase difference of 90° between each output group, each output group, supplying at least one pair; of said top-entering heating electrodes.

3. The glass furnace according to claim 2, wherein at least one output group, of said at least one two-phase transformer supplies a bundle of at least two top-entering heating electrode pairs.

4. The glass furnace according to claim 2, wherein at least one output group of said at least one two-phase transformer comprises one or more outputs.

5. The glass furnace according to claim 3, and wherein each top-entering heating electrode bundle; is arranged in the bath of molten vitrifiable materials in such a way as to respect a central symmetry along a theoretical horizontal plane.

6. The glass furnace according to claim 2, wherein the top-entering heating electrodes of a same output group are arranged in the vicinity of opposite walls of the tank.

7. The glass furnace according to claim 2, wherein said pairs of top-entering heating electrodes powered by the same two-phase transformer are arranged in a quadrilateral configuration along a theoretical horizontal plane in the bath of molten vitrifiable materials.

8. The glass furnace according to claim 1, wherein a minimum distance between each top-entering heating electrode and a nearest tank wall is greater than 450 mm.

9. The glass furnace according to claim 1, wherein each of said top-entering heating electrodes comprises a horizontal projection arm, the horizontal extension of which is greater than 2000 mm.

10. The glass furnace according to claim 2, wherein said electrical installation is adapted so that all pairs of top-entering heating electrodes connected to a same output group of said two-phase transformer are supplied with an electrical current of a same voltage.

11. The glass furnace according to claim 1, wherein the glass furnace is fully electric.

12. The glass furnace according to claim 2, further comprising a plurality of said two-phase transformers.

13. The glass furnace according to claim 1, wherein said melting tank is dimensioned so that said bath of molten vitrifiable materials has a surface area greater than 25 m².

14. The glass furnace according to claim 2, wherein said two-phase transformer supplies a number of top-entering heating electrodes less than or equal to 16.

15. The glass furnace according to claim 2, wherein a number of top-entering heating electrodes per square meter is between 0.1 and 0.45.

16. A method for melting vitrifiable materials using a glass furnace according to claim 1, comprising electrically heating said bath of molten vitrifiable materials by said plurality of top-entering heating electrodes and by applying a two-phase alternating current within said bath.

17. The method for melting vitrifiable materials according to claim 16 wherein all pairs; of top-entering heating electrodes connected to a same output group, of a two-phase transformer are supplied with an electric current of a same voltage.

18. A method for manufacturing glass wool, rock wool, glass textile fibers and/or flat or hollow glass, comprising implementing a melting method according to claim 16.

19. The glass furnace according to claim 3, wherein the at least one output group of said at least one two-phase transformer supplies a bundle of at least three top-entering heating electrode pairs.

20. The glass furnace according to claim 7, wherein said pairs of top-entering heating electrodes powered by the same two-phase transformer are arranged in a in a rectangle or in a square.
